(19) United States
(12) Patent Application Publication
(10) Pub. No.: US 2012/0312480 A1
(43) Pub. Date: Dec. 13, 2012

(54) Mechanical abrasive surface conditioning for wallcovering removal

(76) Inventor: David Buchholz, Olmsted Falls, OH (US)

(21) Appl. No.: 13/373,693

(22) Filed: Dec. 27, 2011

Related U.S. Application Data
(60) Provisional application No. 61/520,520, filed on Jun. 10, 2011.

(51) Int. Cl. B32B 38/10

(52) U.S. Cl. 156/704; 156/703

(57) ABSTRACT

The present invention provides a system and method of mechanical abrasive surface conditioning for wallcovering removal. The method employs a system of mechanized sanding tools and dust collection means that are used to prepare a wallcovering surface for application of an adhesive removing mixture that allows for relatively quick and easy removal of various kinds, styles, ages, etc. of wallcoverings with a minimum of time, effort, and damage to the underlying wall. A key component to the system is the proper marriage of sanding tools utilizing relatively course grit size and the application of the random orbital and/or oscillating motion. The system can thereby reduce the physical effort required to properly abrade the wallcovering surface in order to allow a wetting solution to adequately penetrate the wallcovering such that removal of the wallcovering can be accomplished more easily.

### CROSS-REFERENCE TO RELATED APPLICATIONS

This application claims benefit of U.S. Provisional Application No. 61/520,520 entitled “Mechanical Abrasive Surface Conditioning for Wallpaper Removal” and filed on Jun. 10, 2011, which is specifically incorporated by reference herein for all that it teaches and discloses.

### TECHNICAL FIELD

The invention relates generally to interior decorating and home/business remodeling, and more particularly to a system and method of mechanical abrasive surface conditioning for wallcovering removal.

### BACKGROUND

Decorating and enhancing the interior spaces that make up our homes and businesses has been a common human activity since the human species lived in caves. When we moved into entirely artificial dwellings, the desire to customize and enhance our individual spaces only increased. For at least the last five hundred years, one of the popular means for relatively quickly and easily customizing a particular room has been to hang wallpaper (which includes all types and styles of related wall coverings).

Modern wallpapers span a wide range of types, sizes, colors, patterns, etc. One of the most common wallpapers (also known as wall coverings), and generally the least expensive, is pre-pasted vinyl coated paper, commonly called “strippable” wallpaper. Cloth backed vinyl is fairly common and durable. Paper backed vinyls are generally more expensive and can be significantly more difficult to install. Other types of wallpapers include metallic foil wallpaper, which generally has paper backing, and textile wallpapers including silks, linens, grass cloths, strings, rattan, and actual impressed leaves.

Regardless of the type, style, color, etc. of wallpaper which is initially installed, it is almost a given that future inhabitants or users of a given room will choose to either replace the wallpaper or simply want the room painted. In either case, the wallpaper should be removed. Since most wallpaper is attached to the wall using adhesives that are starch or methylcellulose based, one of the simplest methods of removal is to brush the paper with water. The water then soaks through the paper and saturates the glue, allowing the paper to be peeled off. However, this method does not work well with non-peelable vinyls, as vinyl is not porous. Further, even if the particular type of wallpaper is supposed to be easily removed with this method, many difficulties can develop that reduce the ease and effectiveness of this removal method.

A common modification to the water-removal-process is the mixing of white vinegar with the water as this can help to more quickly break down and dissolve the adhesives. Further, scoring tools, knives, etc. can also be employed to cut open the wallpaper and allow the water or water mixture easier access to the adhesives underlying the wallpaper.

Anyone who has removed or attempted to remove a variety of wallpapers will have found that there are some that will not yield to the above methods. Thus, chemical wallpaper stripping compounds have been developed. Such wallpaper stripper chemicals are usually mixed with water or a mixture of water and vinegar, then sprayed or brushed onto wall surfaces. Several applications may be required to saturate the existing wallpaper. As discussed above, scoring or perforation of the wallpaper before application can aid in the absorption of the mixture and lead to faster removal. The chemical(s) are designed to more aggressively target the adhesives and break them down faster than a water or water/vinegar solution alone. Whichever of the above methods are used to soften the wallpaper and break down the underlying adhesives, the final operations of removal are usually the same: after the adhesive(s) have been dissolved, the wallpaper can be removed by pulling at the edges and stripping it from the wall. Sometimes a putty or drywall knife can be useful during this process.

Another method of removal is to apply steam to wallpaper in order to dissolve the wallpaper paste. A wallpaper steamer consists of a reservoir of water, an electric heating element, and a hose to direct the steam at the wallpaper. The steam dissolves the wallpaper paste, allowing the wallpaper to be peeled off. However, care must be taken to prevent damage to the drywall underneath. Sometimes steaming can lead to the crumbling of underlying drywall or plaster, leaving an uneven surface to be repaired.

Regardless of the care and effort used in applying one or more of the traditional methods detailed above, many wallpaper removers will find that some wallpaper will not yield easily to removal efforts. And, as the amounts of scoring, scraping, chemicals, steam, etc. are increased to deal with recalcitrant wallpapers, the chances of damaging the underlying wall go up dramatically. Furthermore, the amounts of time and effort spent to remove difficult wallpaper can quickly become excessive using the traditionally methods outlined above.

Therefore, what is needed is a system and method of removing wallpaper that is able to overcome even the most stubborn wallpaper while minimizing removal time and associated costs.

### SUMMARY

One embodiment of the present invention provides a system and method of mechanical abrasive surface conditioning for wallpaper removal. The method employs a system of mechanized sanding tools and dust collection means that are used to prepare a wallpaper surface for application of an adhesive removing mixture that allows for relatively quick and easy removal of various kinds, styles, ages, etc. of wallpaper with a minimum of time, effort, and damage to the underlying wall. A key component to the system is the proper marriage of sanding tools utilizing relatively course grit size and the application of the random orbital and/or oscillating motion. The system can thereby reduce the physical effort required to properly abrade the wall covering surface in order to allow a wetting solution to adequately penetrate the wall covering.

### BRIEF DESCRIPTION OF THE FIGURES

The aforementioned and other features and objects of the present invention and the manner of attaining them will become more apparent and the invention itself will be best understood by reference to the following descriptions of a preferred embodiment and other embodiments taken in conjunction with the accompanying figures, wherein:

FIG. 1 illustrates an exemplary embodiment of a method of mechanical abrasive surface conditioning for wallcovering removal;

FIG. 2 shows a perspective view of an exemplary embodiment of a set of tools including an abrasive tool and a dust collection means for preparing a wallcovering for removal via a method of mechanical abrasive surface conditioning for wallcovering removal;

FIG. 3 illustrates a perspective view of an exemplary embodiment of an abrasive tool being utilized according to one embodiment of a method of mechanical abrasive surface conditioning for wallcovering removal;

FIG. 4 illustrates a perspective view of a wall that has had an exemplary embodiment of a mechanical abrasive surface conditioning applied to a plurality of test sections;

FIG. 5 illustrates a perspective view of a wall that has had an exemplary embodiment of mechanical abrasive surface conditioning applied to the entire wall; and

FIG. 6 illustrates an exemplary embodiment of detail steps as a portion of a method of mechanical abrasive surface conditioning for wallcovering removal.

### DETAILED DESCRIPTION

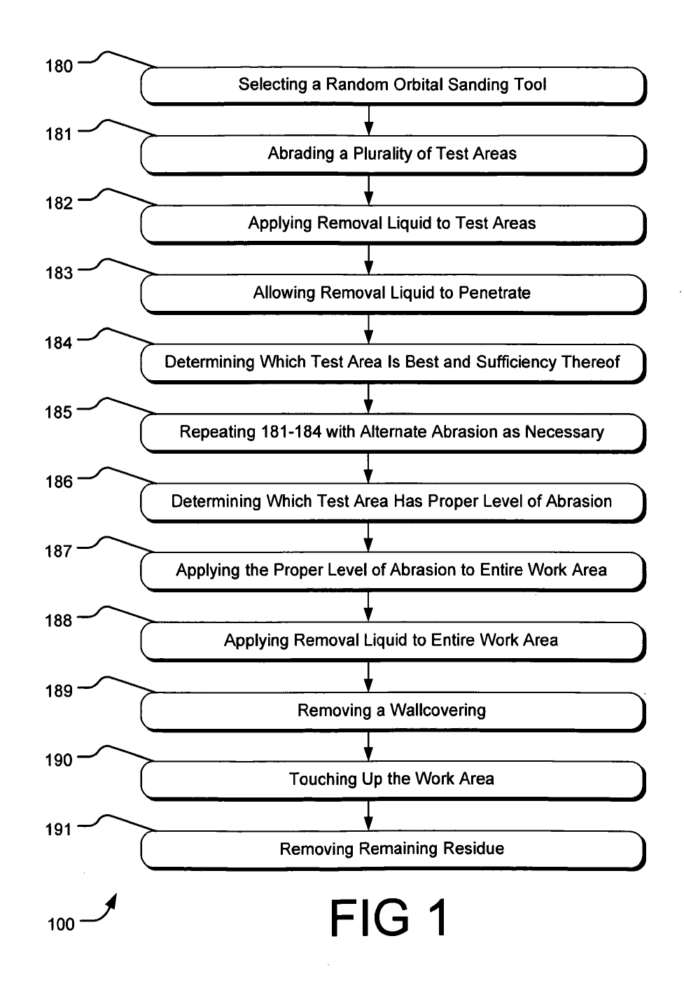

Referring now to the figures, FIG. 1 illustrates an exemplary embodiment of a method of mechanical abrasive surface conditioning for wallcovering removal 100. The method involves the following operations: Selecting a random orbital sanding tool 180, Abrading a plurality of test areas 181, Applying removal liquid to test areas 182, Allowing removal liquid to penetrate 183, Determining which test area is best and sufficiency thereof 184, Repeating 181-184 with alternate abrasion as necessary 185, Determining which test area has proper level of abrasion 186, Applying the proper level of abrasion to entire work area 187, Applying removal liquid to entire work area 188, Removing a wallcovering 589, Touching up the work area 190, and Removing remaining residue 191.

The operation of selecting a random orbital sanding tool 180 involves choosing the appropriate sanding tool for a given area. Small sanding heads are appropriate for small areas, larger heads for larger areas. Furthermore, as discussed above, small triangular, square, etc. vibratory sanding tools may be used in tight spaces such as corners, etc. but otherwise orbital and/or oscillating are preferred.

The type of abrasive paper employed on the sanding tool should also be selected here. Sanding sheets can be coated with natural or synthetic abrasive materials, and a relatively low grit-size is preferred. Generally a twenty-four grit is sufficient. As discussed above, a dust control/collection means should be coupled to the sanding tool and a switch which automatically activates the dust control equipment when the sanding tool is activated can be employed.

The operation of abrading a plurality of test areas 181 involves applying the sanding tool to a selection of test areas and abrading the wallpaper therein. In one embodiment, three test areas are selected and a light, medium, and heavy abrasion is applied, respectively. Often a two feet by two feet (or four square feet) area is an appropriate amount of surface area for a given test area. Test areas can be arranged vertically or horizontally, or in any manner that is deemed practical. In other embodiments, the number of test areas can be less than or more than three. Similarly, the size and relative placement of test areas can vary in other embodiments as well.

The operation of applying removal liquid to test areas 182 involves spraying or otherwise applying the removal liquid to the various test areas. Care should be taken to apply a similar amount of removal liquid by generally similar means to each test area. As discussed above, the removal liquid can include water, vinegar, chemical strippers, etc.

The operation of allowing the removal liquid to penetrate the test area 183 involves waiting for the removal liquid to penetrate through the abrasions in the wall paper and act on the underlying adhesive(s). The required time varies depending on many factors but is usually two to three minutes but can be ten to fifteen minutes or more. If the penetration is taking too long, a deeper abrasion test area may be warranted.

The operation of determining which test area is best and sufficiency thereof 184 involves examining the plurality of test areas and attempting to remove the wallpaper thereon. The wallpaper should release relatively smoothly/easily without having too much removal liquid or otherwise damaging the underlying wall. Once the best test area is determined, it should be examined to see if it has a sufficient level of abrasion.

The operation of repeating 181-184 with alternate abrasion as necessary 185 involves determining if the best test area was sufficiently abraded or over-abraded. If the best test area was either over- or under-abraded, new test areas can be selected and operations 181-184 can be repeated as necessary.

The operation of determining which test area has the proper level of abrasion 186 involves selecting the proper abrasion level from all the test areas. A properly abraded wallpaper test area will allow relatively easy removal of the wallpaper while minimizing the amount of abrasion, removal liquid, and wall damage.

The operation of applying the proper level of abrasion to the entire work area 187 involves applying a similar level of abrasion as that used on the selected test area from the previous operation to the entire work area.

The operation of applying removal liquid to entire work area 188 involves applying the removal liquid in a generally uniform manner to the entire work area.

The operation of removing the wallcovering 189 involves utilizing the means and methods described above as well as other methods known in the art for removing the wallcovering from the wall. As discussed above, a scraper, knife, etc. can be used to help in pealing or stripping the properly prepared wallcovering from the wall.

The operation of touching up the work area 190 involves removing any remaining backing and paste using commonly accepted wallcovering removal practices.

The operation of removing remaining residue 191 involves using a scrubbing pad such as a floor wax removal pad or a heavy duty scour pad, etc., to scrub any remaining paste, paste residue, or other remaining residue off the wall.

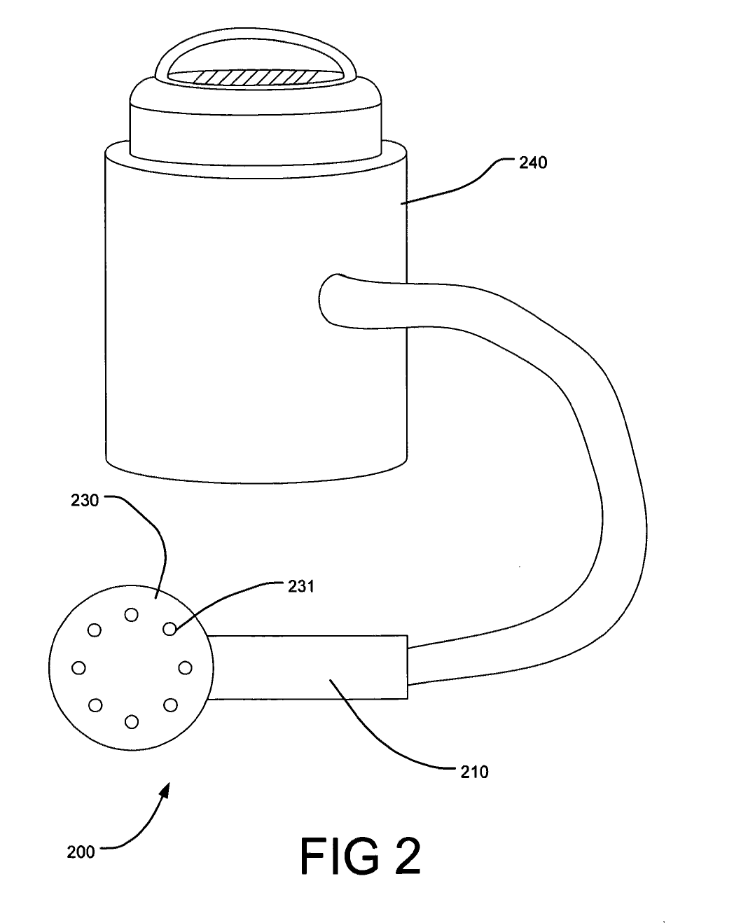

FIG. 2 shows a perspective view of an exemplary embodiment of a set of tools 200 including an abrasive tool 210 and a dust collection means 240 for preparing a wallcovering for removal via a method of mechanical abrasive surface conditioning for wallcovering removal. The abrasive tool 210 can be any of a number of different mechanical abrasion tools. However, common belt sanders and rotary sanders are not preferred as these tend to abrade in fixed, predefined motions that over-abrade in some areas and under-abrade in others. Instead, preferred embodiments utilize random-orbit abrasive tools such as 110 that evenly abrade an entire surface.

An exemplary random-orbit abrasion head 230 is also shown in FIG. 2. The abrasion head 230 has dust-collection ports 231 that apply the vacuum created by the dust collection means 240 to the work area in order to collect the dust that is created by using the abrasive tool 210 on a wallcovering.

Once all the primary areas have been abraded using the random abrasion tools, small, difficult to reach areas can be abraded using vibratory abraders such as a triangular head abrader; otherwise, oscillating and/or random orbital devices are preferred. Whichever abrader is used, it should be coupled to dust collection equipment 240. The abrasive tool 210 should then be applied to a plurality of test areas on a wall. Although the number of test areas can be one, two, three or more, in one embodiment three test areas are employed. The first area should be lightly abraded, the second area should have a medium abrasion, and the third area should be more heavily abraded. In a preferred embodiment, the abrasion test areas can be approximately two by two feet or four square feet each.

The dust collection means 240 can be a standard or high-powered shop-vacuum that automatically activates when the abrasive tool 210 is activated. It is preferred not to employ the vacuum filter that comes standard, but instead utilize a collection bag. Any kind of dust collection vacuum, cyclonic unit, or anything that draws particles away from the surface and then contains them so they don't disperse over the entire work area can be used.

Once the abrasion test areas have been properly abraded, water or a mixture of water, vinegar and/or stripper chemicals can be applied to each test area and allowed to penetrate the wallpaper. The test areas should then be examined and wallpaper removal attempted to determine which level of abrasion (light, medium or heavy) is appropriate for the given wallpaper. The appropriate abrasion level can then be applied to the remainder of the wall. It is important to utilize the lightest abrasion level possible that provides for easy wallpaper removal as over-abrading can damage the wall, is labor- and time-intensive and is overly costly.

Employing dust collection means 240 is important as this minimizes the amount of dust that is otherwise dispersed throughout the air. Such airborne dust not only spreads throughout a home or office requiring excess post-removal cleaning, but is also a health hazard to those people who would otherwise be breathing any dust-laden air.

The instant invention offers vast improvements over traditional wallpaper removal methods. Using a knife or scoring tool only provides a small number of widely spaced entry points for the water or stripping mixture to enter the wallpaper and attack the adhesives. The instant method provides a vast amount of closely spaced access points and so the mixture can quickly and evenly penetrate the wallpaper and break down the adhesives holding the wallpaper to the wall. If employed correctly, the above described abrasion operation only needs to be done once, whereas scoring usually must be done repeatedly with a number of applications of the water/mixture and wallpaper removal attempts between each scoring.

Dry shaving can be employed instead of scoring, but this method of wallpaper removal is difficult to master and must be done with the right amount of finesse or you will end up gouging the underlying wall. The instant method can be learned quickly and does not take the large amount of practice and experience to master as required by dry shaving. Further, the chances of damaging the wall are far reduced using the method as compared to razor knife scraping/dry shaving.

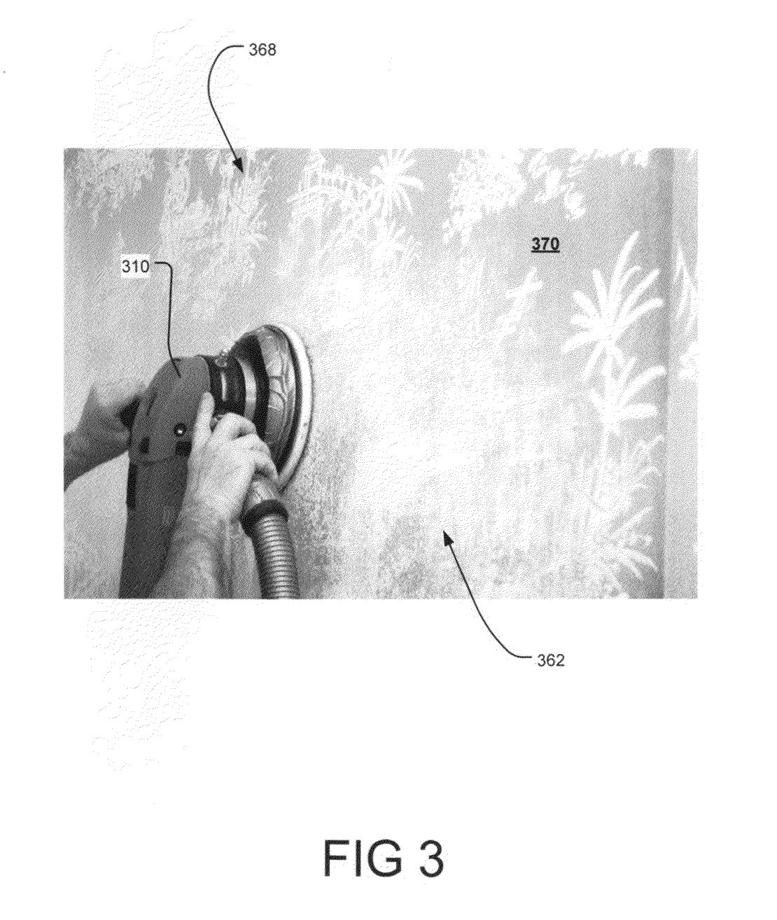

FIG. 3 illustrates a perspective view of an exemplary embodiment of an abrasive tool 310 being utilized according to one embodiment of a method of mechanical abrasive surface conditioning for wallcovering removal on a sample wall 370. The figure contains a black and white photograph in lieu of a drawing as the photograph is necessary to show the detail of the effect that the abrasive surface conditioning has on a wallcovering. Approximation through representation via a drawing doesn't adequately convey the necessary detail and so a photograph is the only practicable medium for illustrating the claimed invention.

As the wallpaper is abraded, the operator can see the amount of abrasion that is occurring and can regulate the proper amount as he progresses across the wall 370. An abraded area 362 is shown as is an un-abraded area 368.

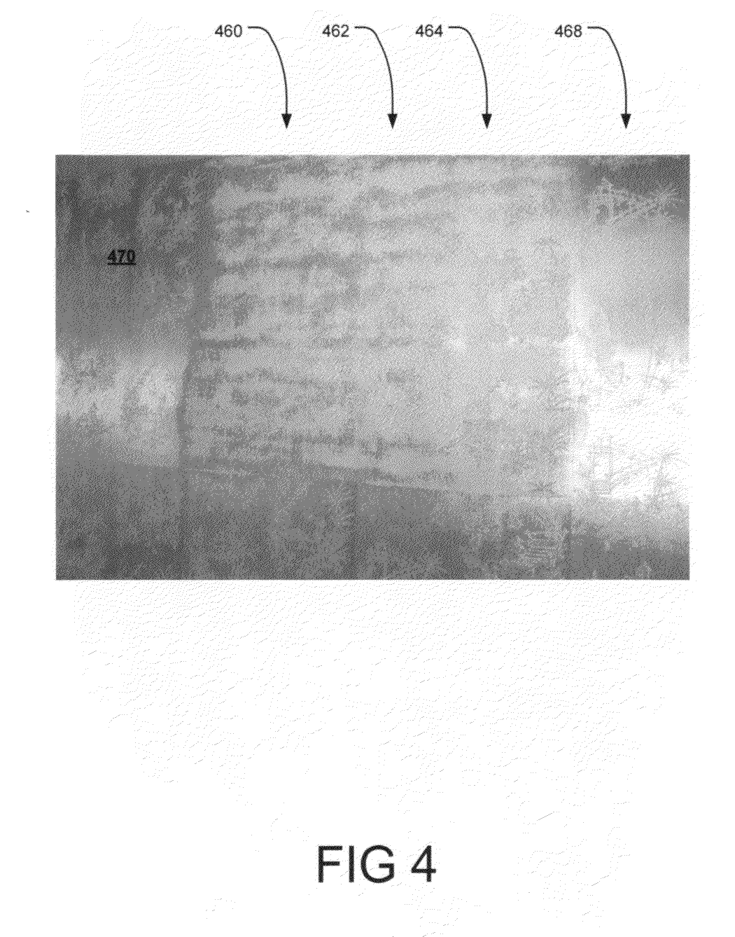

FIG. 4 illustrates a perspective view of a wall 470 that has had an exemplary embodiment of a mechanical abrasive surface conditioning applied to a plurality of test sections 460, 462, and 464. The figure contains a black and white photograph in lieu of a drawing as the photograph is necessary to show the detail of the effect that the abrasive surface conditioning has on a wallcovering. Approximation through representation via a drawing does not adequately convey the necessary detail and so a photograph is the only practicable medium for illustrating the claimed invention. The un-abraded wall areas 468 can be seen. In comparison, a light-abrasion test section 460, a medium-abrasion test section 462, and a heavy-abrasion test section 464 are also illustrated.

As discussed above, once the abrasion test sections 460, 462, and 464 have been created, water and/or a mixture is applied to the sections 460, 462, and 464. The mixture can be water, water and vinegar, water and soap, water and stripper chemicals, etc. Soap (or other additions) can be used in the water to break up the surface tension of the water and make it penetrate better. Known commercial wallpaper removal products (also known as stripper chemicals) can be bought at paint and wallpaper stores. Such chemicals or expensive mixtures can be employed but are not necessary when using the instant invention as proper abrading as described herein is so effective that plain water can be used instead.

Regardless of the water or mixture that is chosen, it can be applied in various ways such as a sponge, brush, sprayer, rag, etc. In one embodiment, the water or mixture is sprayed on using a hand pump sprayer. In another embodiment, a low pressure power pump sprayer is used. In yet another embodiment, an atomization spray method such as an airless paint sprayer can be used. Other methods of applying the water or mixture are contemplated in other embodiments.

Once the wallpaper is properly hydrated with water or mixture, the actual removal of the wallpaper can take place. A common method of removing the hydrated wallpaper is to use either a three to six inch broad knife to loosen and separate the material from the wall. Because the instant abrasion methods are so effective, properly hydrated wallpaper will sometimes begin to fall off the wall on its own. Since over-hydration is best avoided, a knife or scraper can by employed to help it along. Putty knives or drywall taping knives can be used with a kind of scraping action. One will quickly note that the amount of scraping and other labor required to remove the wallpaper once it has been properly hydrated after correct abrasion is vastly reduced when compared to other wallpaper removal methods currently known in the art.

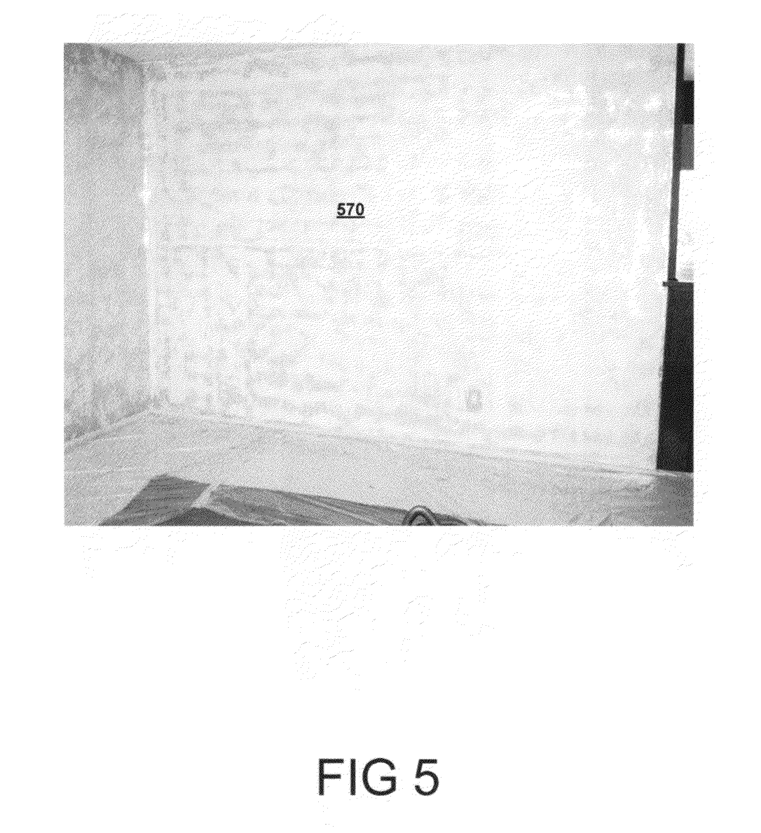

FIG. 5 illustrates a perspective view of a wall 570 that has had an exemplary embodiment of mechanical abrasive surface conditioning applied to the entire wall. The wall 570 is ready for application of water or mixture which is then allowed to penetrate before the wallpaper is removed. The figure contains a black and white photograph in lieu of a drawing as the photograph is necessary to show the detail of the effect that the abrasive surface conditioning has on a wallcovering. Approximation through representation via a drawing does not adequately convey the necessary detail and so a photograph is the only practicable medium for illustrating the claimed invention.

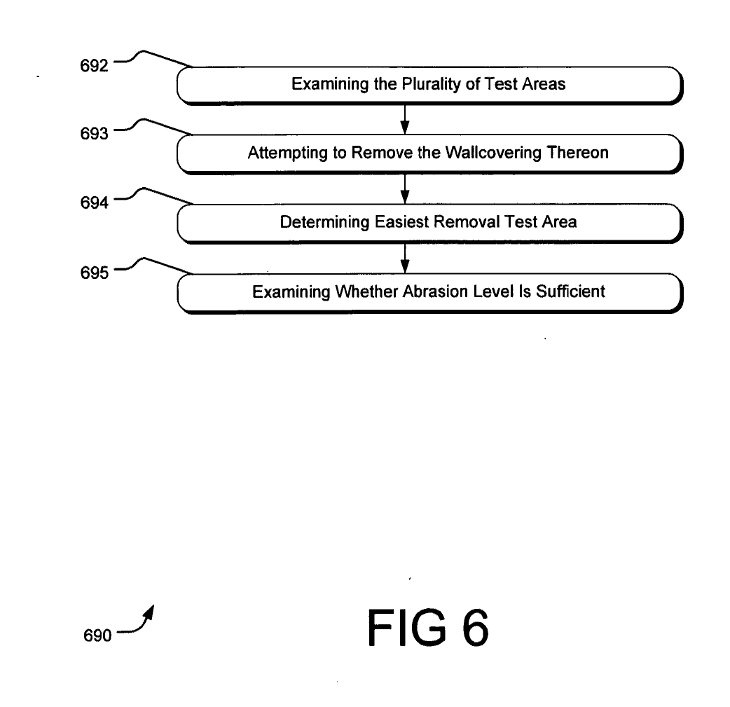

FIG. 6 illustrates an exemplary embodiment of detail steps as a portion of a method of mechanical abrasive surface conditioning for wallcovering removal. The steps in FIG. 6 include: examining the plurality of test areas 692, attempting to remove the wallcovering thereon 693, determining in which test area the wallcovering most easily can be removed without too much removal liquid or damage to the wall 694, and examining whether the level of abrasion on the determined test area is sufficient 695.

The above specification, examples and data provide a description of the structure and use of exemplary implementations of the described articles of manufacture and methods. It is important to note that many implementations can be made without departing from the spirit and scope of the invention.

What is claimed is:

1. A method of mechanical abrasive surface conditioning for wallcovering removal from a wall, the method comprising:
selecting a random orbital sanding tool;
abrading a plurality of test areas;
applying removal liquid to test areas;
allowing removal liquid to penetrate;
determining which test area is best and sufficiency thereof;
repeating prior operations with alternate abrasion as necessary;
determining which test area has a proper level of abrasion;
applying the proper level of abrasion to an entire work area;
applying removal liquid to the entire work area;
removing a wallcovering;
touching up the entire work area; and
removing remaining residue.

2. The method of mechanical abrasive surface conditioning for wallcovering removal of claim 1, wherein selecting a random orbital sanding tool comprises selecting from among a plurality of random orbital sanding tools and at least one relatively small-headed vibratory sanding tool.

3. The method of mechanical abrasive surface conditioning for wallcovering removal of claim 1, wherein abrading a plurality of test areas includes abrading at least three test areas using the selected sanding tool.

4. The method of mechanical abrasive surface conditioning for wallcovering removal of claim 2, wherein abrading a plurality of test areas includes abrading at least three test areas using the selected sanding tool.

5. The method of mechanical abrasive surface conditioning for wallcovering removal of claim 1, wherein the removal liquid is selected from among at least: water, vinegar, and chemical strippers.

6. The method of mechanical abrasive surface conditioning for wallcovering removal of claim 2, wherein the removal liquid is selected from among at least: water, vinegar, and chemical strippers.

7. The method of mechanical abrasive surface conditioning for wallcovering removal of claim 3, wherein the removal liquid is selected from among at least: water, vinegar, and chemical strippers.

8. The method of mechanical abrasive surface conditioning for wallcovering removal of claim 1, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

9. The method of mechanical abrasive surface conditioning for wallcovering removal of claim 2, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

10. The method of mechanical abrasive surface conditioning for wallcovering removal of claim 3, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

11. The method of mechanical abrasive surface conditioning for wallcovering removal of claim 4, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

12. The method of mechanical abrasive surface conditioning for wallcovering removal of claim 5, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

13. The method of mechanical abrasive surface conditioning for wallcovering removal of claim 6, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

14. The method of mechanical abrasive surface conditioning for wallcovering removal of claim 7, wherein determining which test area is best and sufficiency thereof further comprises:
examining the plurality of test areas;
attempting to remove the wallcovering thereon;
determining in which test area the wallcovering most easily can be removed without too much removal liquid or damage to the wall; and
examining whether the level of abrasion on the determined test area is sufficient.

15. The method of mechanical abrasive surface conditioning for wallcovering removal of claim 1, wherein applying the proper level of abrasion to an entire work area further comprises using the selected sanding tool to apply the proper level of abrasion to the entire work area.

16. The method of mechanical abrasive surface conditioning for wallcovering removal of claim 3, wherein applying the proper level of abrasion to an entire work area further comprises using the selected sanding tool to apply the proper level of abrasion to the entire work area.

17. The method of mechanical abrasive surface conditioning for wallcovering removal of claim 5, wherein applying the proper level of abrasion to an entire work area further comprises using the selected sanding tool to apply the proper level of abrasion to the entire work area.

18. The method of mechanical abrasive surface conditioning for wallcovering removal of claim 7, wherein applying the proper level of abrasion to an entire work area further comprises using the selected sanding tool to apply the proper level of abrasion to the entire work area.

19. The method of mechanical abrasive surface conditioning for wallcovering removal of claim 8, wherein applying the proper level of abrasion to an entire work area further comprises using the selected sanding tool to apply the proper level of abrasion to the entire work area.

20. The method of mechanical abrasive surface conditioning for wallcovering removal of claim 9, wherein applying the proper level of abrasion to an entire work area further comprises using the selected sanding tool to apply the proper level of abrasion to the entire work area.
